(19) United States
(12) Patent Application Publication
(10) Pub. No.: US 2019/0274495 A1
(43) Pub. Date: Sep. 12, 2019

(54) LIGHTED TOILET FOOTREST

(71) Applicant: Squatty Potty, LLC, St. George, UT (US)

(72) Inventors: Dennis Leavitt, St. George, UT (US); Bernard R. Kropfelder, St. George, UT (US)

(73) Assignee: Squatty Potty, LLC, St. George, UT (US)

(21) Appl. No.: 16/298,958

(22) Filed: Mar. 11, 2019

Related U.S. Application Data
(60) Provisional application No. 62/641,188, filed on Mar. 9, 2018.

(51) Int. Cl. A47K 17/02; F21V 23/04

(52) U.S. Cl. CPC A47K 17/028; F21V 23/0464; F21V 23/0471

(57) ABSTRACT

A lighted toilet footrest has a foot platform, a sidewall extending downwardly from the foot platform, a plurality of legs, and a sensor unit, the sensor unit comprising a light sensor, a motion sensor, one or more lights, and optionally a diffuser.

### CROSS-REFERENCE TO RELATED APPLICATIONS

This application claims the benefit of U.S. Provisional Application Ser. No. 62/641,188, filed on Mar. 9, 2018, which is incorporated herein by reference.

### TECHNICAL FIELD

The present disclosure relates to footrests. More specifically, the present disclosure relates to a toilet footrest with motion-activated light for use while on a toilet.

### BACKGROUND

Humans can perform defecation in different postures; the two most common are squatting or sitting positions. The squatting posture is usually used when using a squat toilet (mainly a feature of the developing world), or when toilets are unavailable. The sitting posture during defecation is a standard posture seen in the western world because western-style toilets usually require a sitting position with the back erect and the knees away from the chest in about a ninety-degree angle.

The anorectal angle, which is the angle formed in the colon where the puborectalis muscle wraps around the rectum, is a very important factor in maintaining continence. The sitting posture common to western-style toilets causes a narrowing of the anorectal angle and prevents the puborectalis muscle from relaxing, which may cause difficulty in emptying the bowels.

Additionally, the sitting position may cause the person to repeat the Valsalva maneuver, i.e., exhalation against a closed airway to increase internal pressure, holding his breath to increase internal pressure, which can lead to syncope. A sitting posture may increase issues related to weakness in the colon wall because of the increased straining needed to defecate.

In contrast, the squatting defecation posture involves squatting by standing with the knees and hips sharply bent and the buttocks suspended near the ground. By using the squatting defecation posture, the anorectal angle is increased, which allows the puborectalis muscle to fully relax, which aids defecation by reducing the amount of effort needed to empty the bowels.

The advantages of the squatting position may be obtained when using western-style toilets (i.e., where the bowl is raised from the ground and is intended for sitting as opposed to squatting) in conjunction with a footrest. Footrests help raise the knees toward the chest and help to lessen the normal sitting angle of about ninety-degrees to much less. As the feet are raised, the puborectalis muscle relaxes, the colon aligns allowing gravity to aid evacuation, and the required expulsive effort lessens. As such, several footrests exist in the art that are aimed at allowing a human to achieve a better anorectal angle while sitting on a toilet.

However, users often enter the bathroom at night or when it is otherwise dark, and may not wish to turn on the overhead lights. As a result, many homes have nightlights that aid a person in seeing when they enter a dark bathroom. However, the lights often occupy a needed or wanted outlet, and may therefore not be ideal. Further, many nightlights are placed in an outlet that may not fully illuminate the toilet or its surroundings. This makes it difficult for users to use the toilet without turning on additional lights. The prior art has attempted to solve these problems in a variety of ways, including lighting the inner portion of the toilet bowl. However, while this illuminates the interior of the toilet, it is not useful in illuminating the exterior, floor portion of the toilet. This is critical, as a user may become injured if they cannot see what is on the floor, and may even stub a toe or foot on the toilet itself for lack of illumination. Further, a user desiring to use a toilet footrest encounters additional peril if the floor or footrest is not properly lit. Therefore, the present invention seeks to solve these and other problems.

### SUMMARY OF EXAMPLE EMBODIMENTS

The present disclosure is directed to a lighted toilet footrest. In one embodiment, the toilet footrest is at least partially manufactured from acrylic (or other transparent material), such that lights (e.g., LEDs) may be used to illuminate the entire footrest, or at least a majority thereof. This gives the entire footrest a “glowing” look. The lights may be motion activated and/or switch controlled. The lights may be battery powered or connected to an electrical outlet. In one embodiment, a housing comprises batteries, a motion sensor, a light sensor, and one or more lights. The housing may be located along any edge of the footrest, such that light enters the acrylic, illuminating the entire footrest. In one embodiment, the housing is coupled to the bottom of the sidewall, with the footrest resting atop the housing. In another embodiment, the housing is coupled to the underside of the foot platform.

In one embodiment, a toilet footrest is opaque, wherein the underside of the footrest comprises a housing coupler for receiving a housing, the housing comprising batteries, a motion sensor, a light sensor, and one or more lights. The housing may further comprise a diffuser, wherein the diffuser is configured to provide aromatherapy.

### BRIEF DESCRIPTION OF THE DRAWINGS

FIG. 1 is a front perspective view of a lighted toilet footrest;

FIG. 2 is a top plan view of a lighted toilet footrest;

FIG. 3 is a front elevation view of a lighted toilet footrest;

FIG. 4 is a back elevation view of a lighted toilet footrest;

FIG. 5 is a side elevation view of a lighted toilet footrest;

FIG. 6 is a bottom plan view of a lighted toilet footrest;

FIG. 7 is a bottom, back exploded perspective view of a lighted toilet footrest;

FIG. 8 is a top, front exploded perspective view of a lighted toilet footrest;

FIG. 9 is a bottom perspective view of a sensor unit of a lighted toilet footrest;

FIG. 10 is a top perspective view of a sensor unit of a lighted toilet footrest;

FIG. 11 is a side perspective view of an alternate sensor unit of a lighted toilet footrest with housing clip attached;

FIG. 12 is a side perspective view of an alternate sensor unit of a lighted toilet footrest without a housing clip attached;

FIG. 13 is side perspective view of an alternate sensor unit of a lighted toilet footrest without a housing clip attached;

FIG. 14 is an exploded perspective view of an alternate sensor unit of a lighted toilet footrest; and

FIG. 15 is an exploded side elevation view of an alternate sensor unit of a lighted toilet footrest.

### DETAILED DESCRIPTION OF EXAMPLE EMBODIMENTS

The following descriptions depict only example embodiments and are not to be considered limiting of its scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various different sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

The present disclosure is directed to a lighted toilet footrest. In one embodiment, not shown, the toilet footrest is at least partially manufactured from acrylic (or other transparent material), such that lights (e.g., LEDs) may be used to illuminate the entire footrest, or at least a majority thereof. This gives the entire footrest a “glowing” look. The lights may be motion activated and/or switch controlled. The lights may be battery powered or connected to an electrical outlet. In one embodiment, a housing comprises batteries, a motion sensor, a light sensor, and one or more lights. The housing may be located along any edge of the footrest, such that light enters the acrylic, illuminating the entire footrest. In one embodiment, the housing is coupled to the bottom of the sidewall, with the footrest resting atop the housing. In another embodiment, the housing is coupled to the underside of the foot platform. As an example of use, when the bathroom is dark, as determined by the configuration of the light sensor (e.g., photoresistor, photodiode, phototransistor), the light will be ready for illumination. Accordingly, when the motion sensor (e.g., passive infrared, microwave, ultrasonic, etc.) detects motion, the light (e.g., one or more LEDs) illuminates. Because the light is as the edge of the footrest, the light penetrates the acrylic, creating the glowing effect. Therefore, when a user enters the dark bathroom, the footrest illuminates (having the appearance of “glowing”), which also illuminates the floor, toilet, and surroundings areas. This overcomes the aforementioned problems in the prior art.

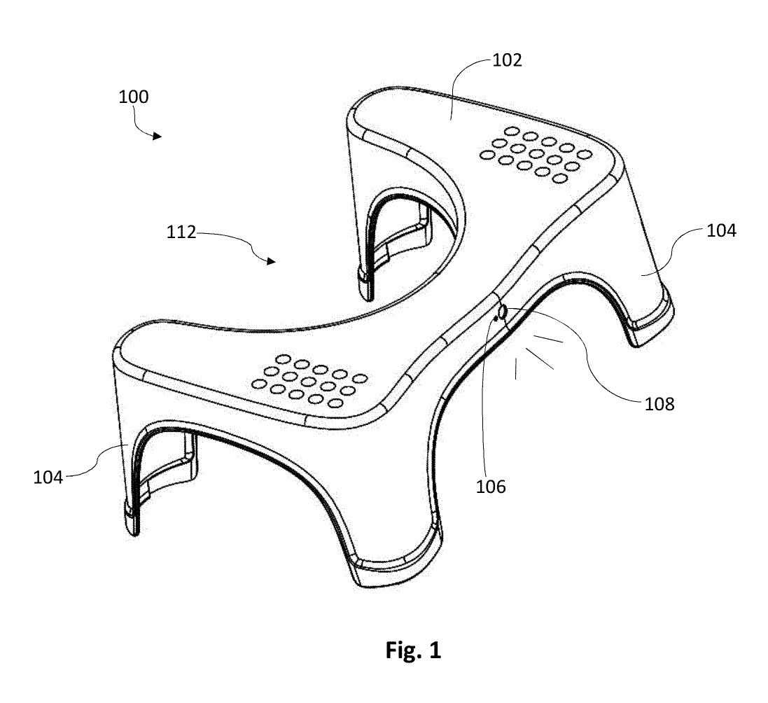

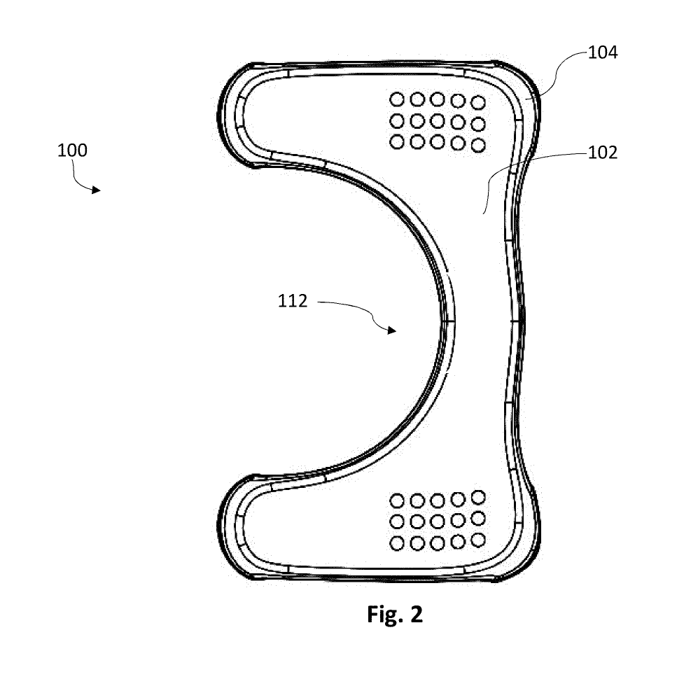

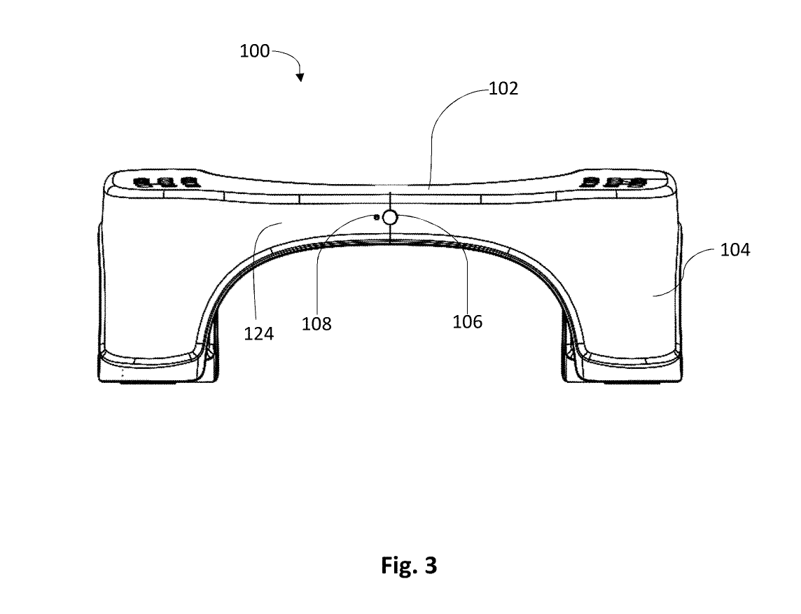

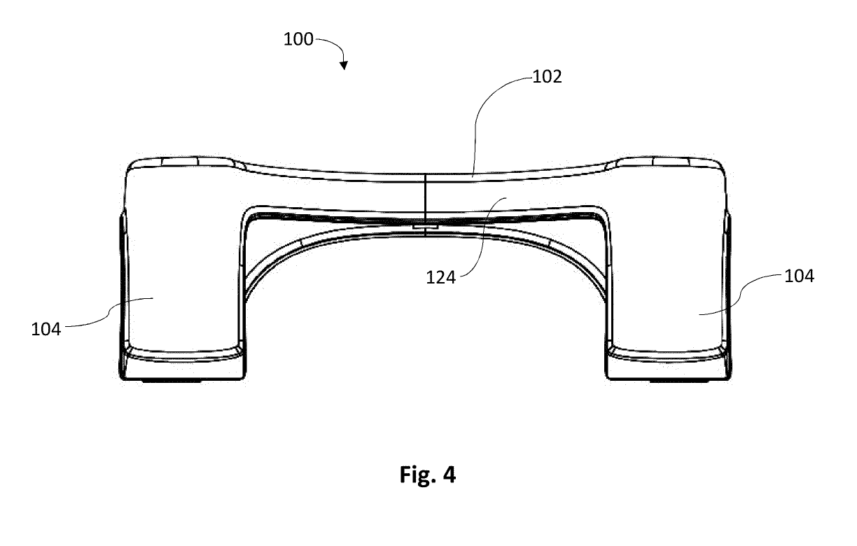

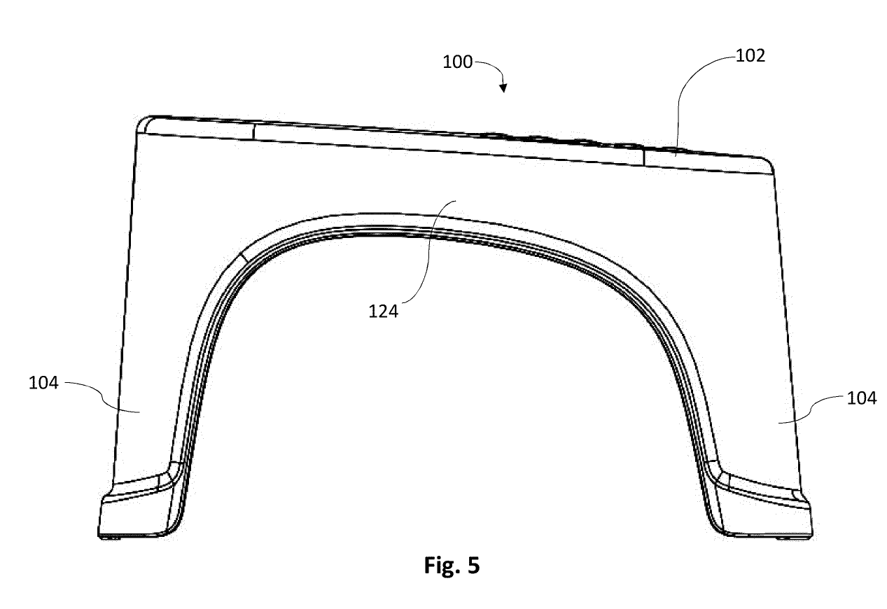

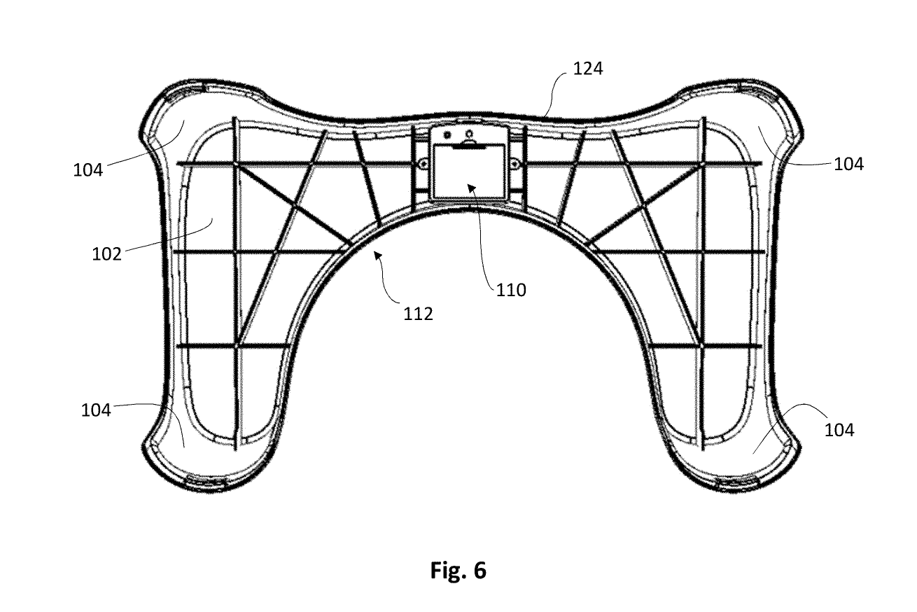

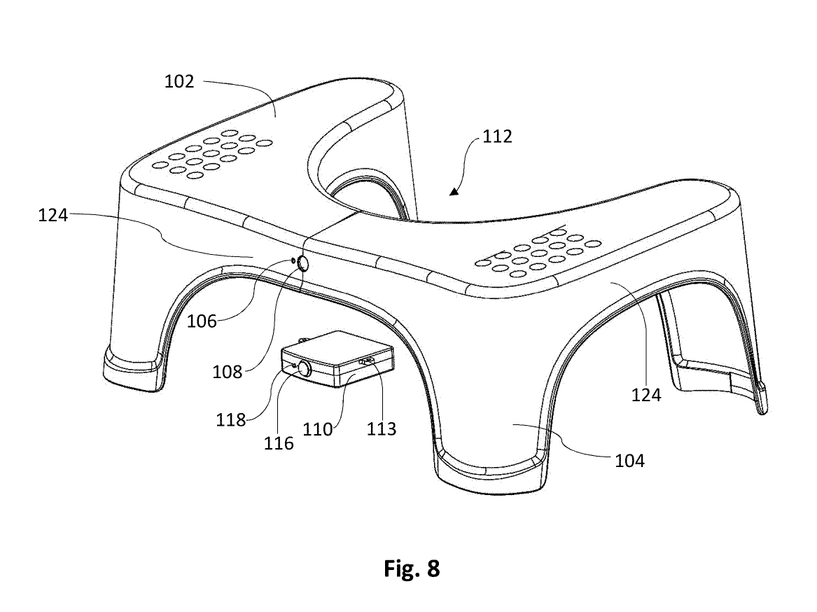

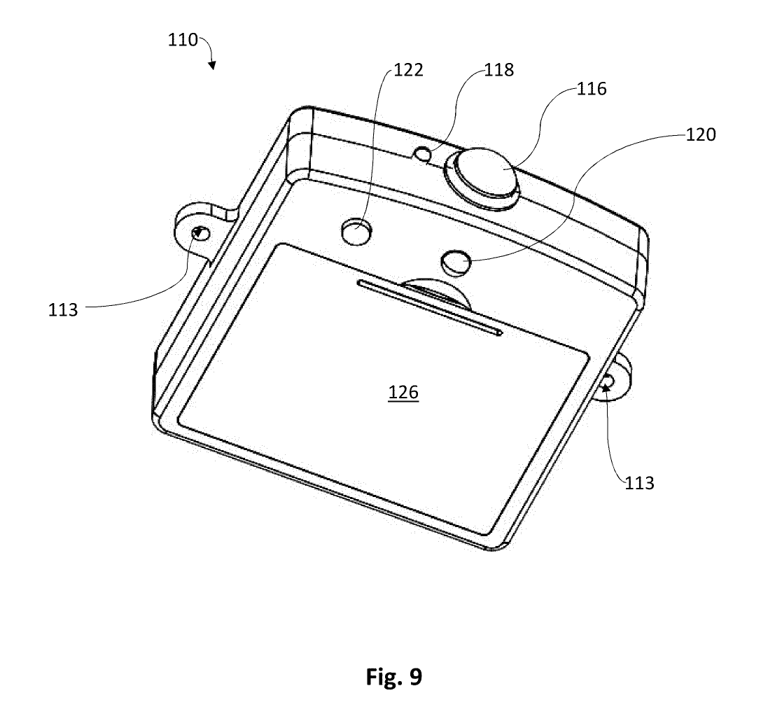

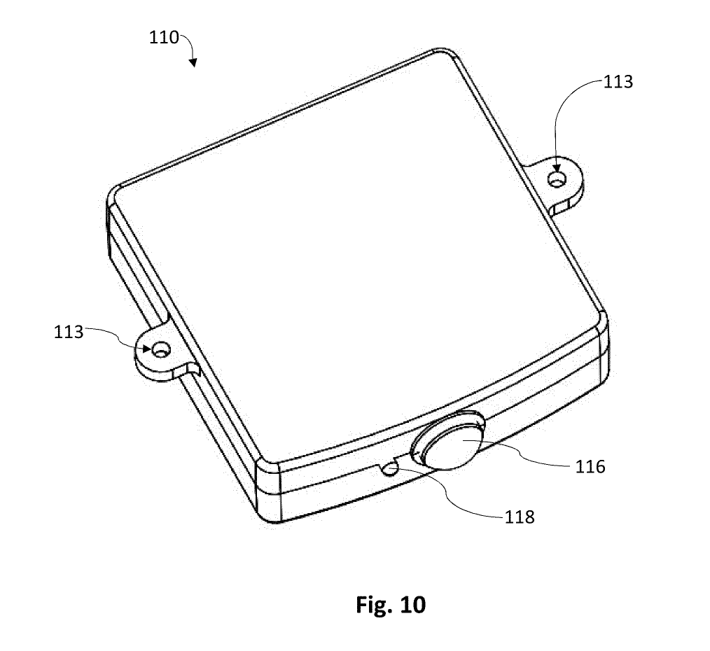

In one embodiment, as shown in FIGS. 1-8, a lighted toilet footrest 100 may be opaque and configured to illuminate the floor when motion is sensed. Toilet footrest 100 comprises a foot platform 102, one or more legs 104, a light sensor aperture 106, a motion sensor aperture 108, and a sensor unit 110 (FIGS. 6-10). Platform 102 may further comprise semi-circular curvature 112, which allows the lighted toilet footrest 100 to take up minimal space at the base of a toilet, while also allowing the user a variety of foot placements. However, while not illustrated herein, other configurations may be suitable, such as rectangular, square, semi-ovular, small cutouts to no cutouts at all, etc.

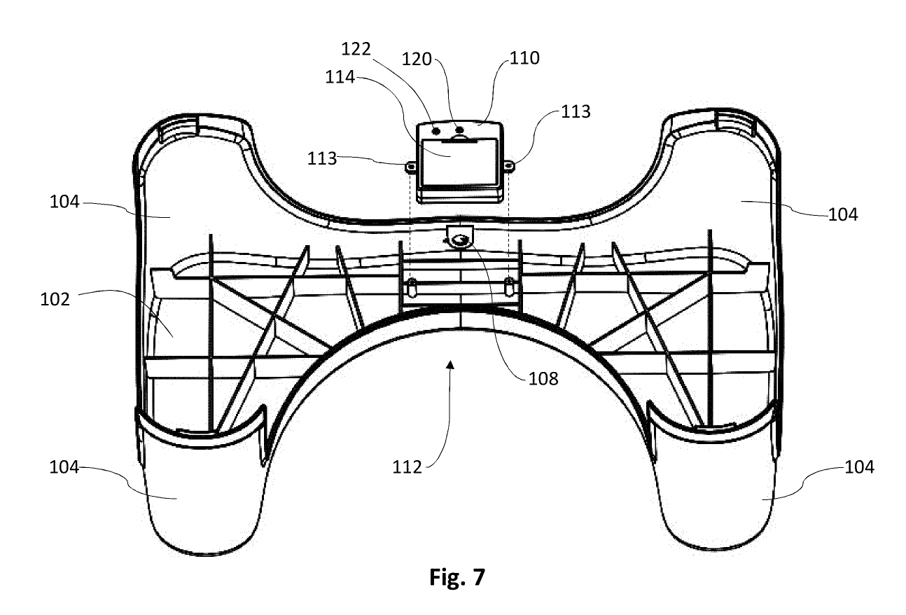

As shown in FIG. 7, the sensor unit 110 is coupleable to the underside of the platform 102. This may be accomplished via screws through screw apertures 113 or by using similar fastening means. The sensor unit 110 comprises battery housing 114, a motion sensor 116, a light sensor 118, one or more lights 120, and optional power button 122. For example, the sensor unit 110 is coupled to the underside of the platform 102 so as to not be visible to a user for enhanced aesthetics. The light sensor 118 is received through light sensor aperture 106 and motion sensor 116 is received in motion sensor aperture 108 in sidewall 124 extending downward from the platform 102. As an example of use, when the bathroom is dark, as determined by the configuration of the light sensor 118 (e.g., photoresistor, photodiode, phototransistor, etc.), the light 120 (e.g., LED) will be ready for illumination. Accordingly, when the motion sensor 116 (e.g., passive infrared, microwave, ultrasonic, etc.) detects motion, one or more lights 120 illuminate. Batteries may be inserted through battery door 126.

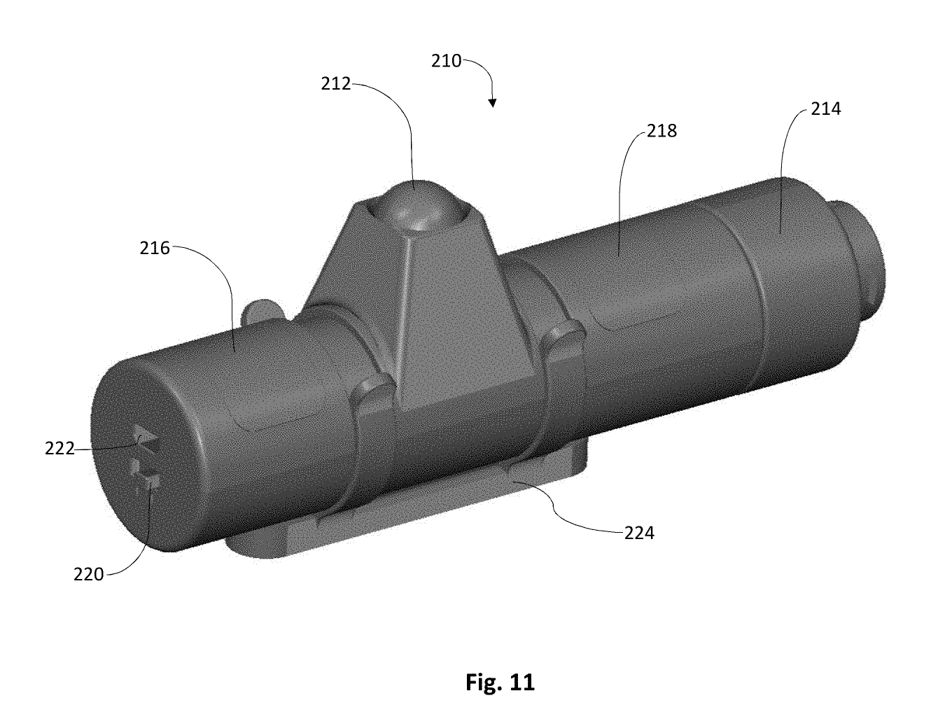

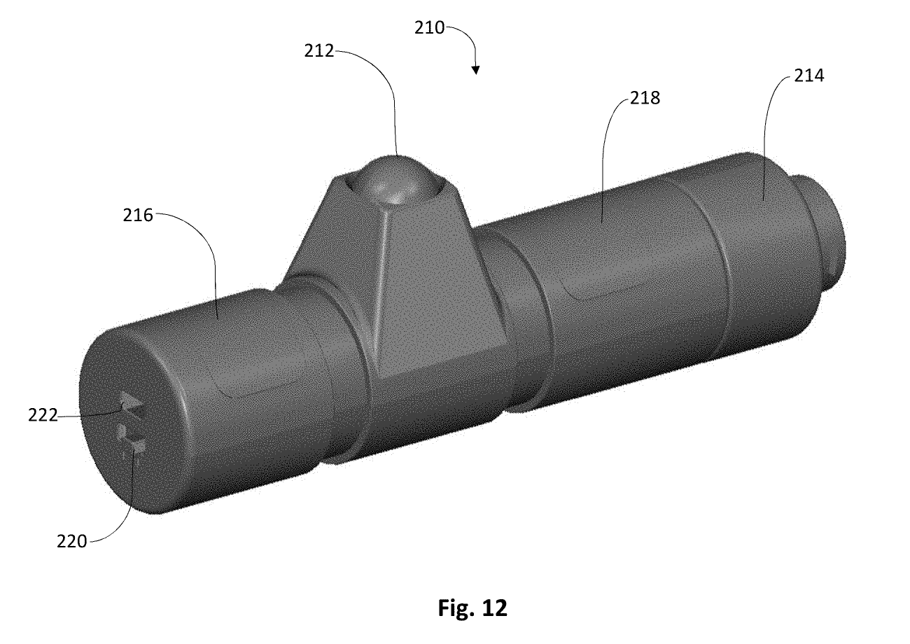

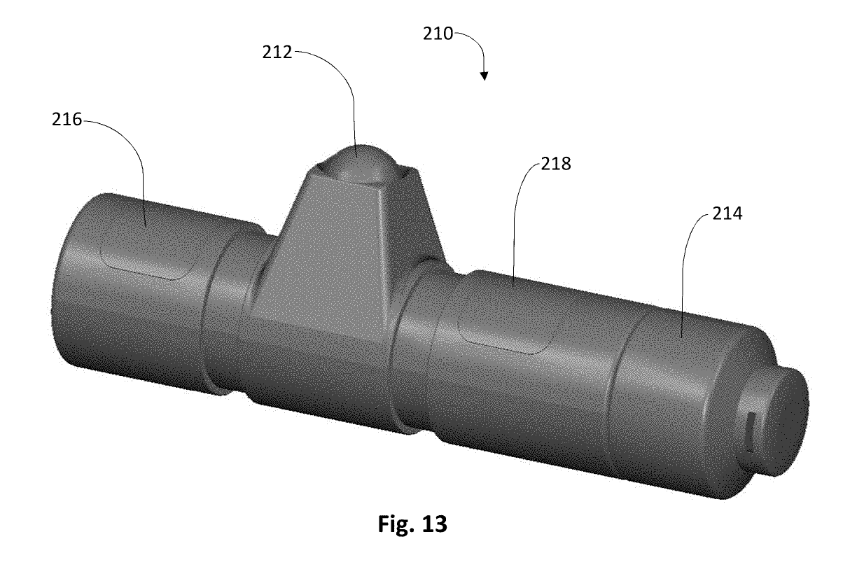

FIGS. 11-15 illustrate an alternate sensor unit 210 for use with a lighted toilet footrest 100. The sensor unit 210 comprises a motion sensor 212 and a diffuser 214, wherein the diffuser 214 is configured to provide aromatherapy. The sensor unit 210 may further comprise one or more lights 216, 218, such as LEDs, and a light sensor (as described earlier herein). The lights 216, 218 are controlled according to both the light sensor and the motion sensor 212. However, the diffuser 214 may be controlled by the motion sensor 212 alone. In such an example, if a user enters a bathroom that is illuminated, the light 216, 218 on the footrest will not illuminate, but the diffuser 212 may still be activated. The diffuser 212 may provide aromatherapy to a user using the toilet. For example, by using essential oils in connection with the diffuser 212, a user may experience a pleasant aroma while using the bathroom. The sensor unit 210 may further comprise an on/off/dimmer switch 220 and a charging port 222 for charging an internal battery, such as Lithium Ion.

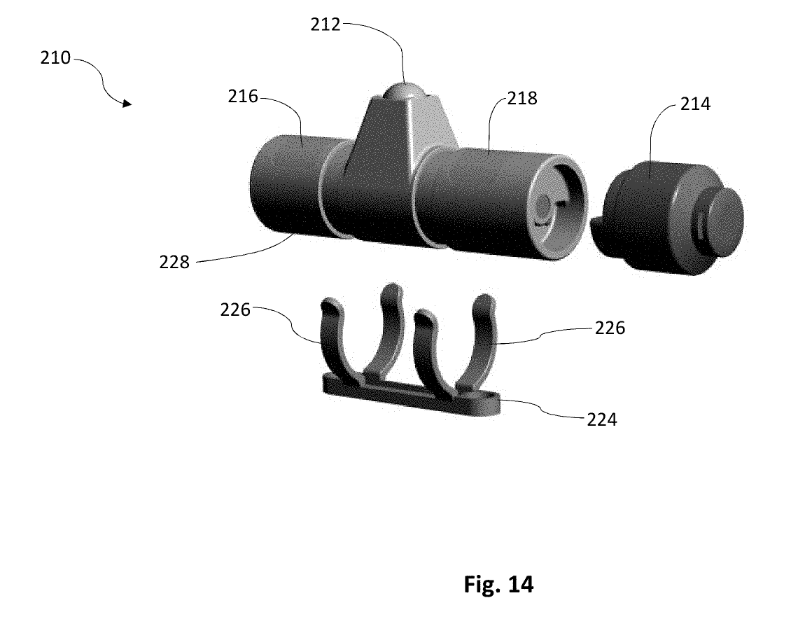

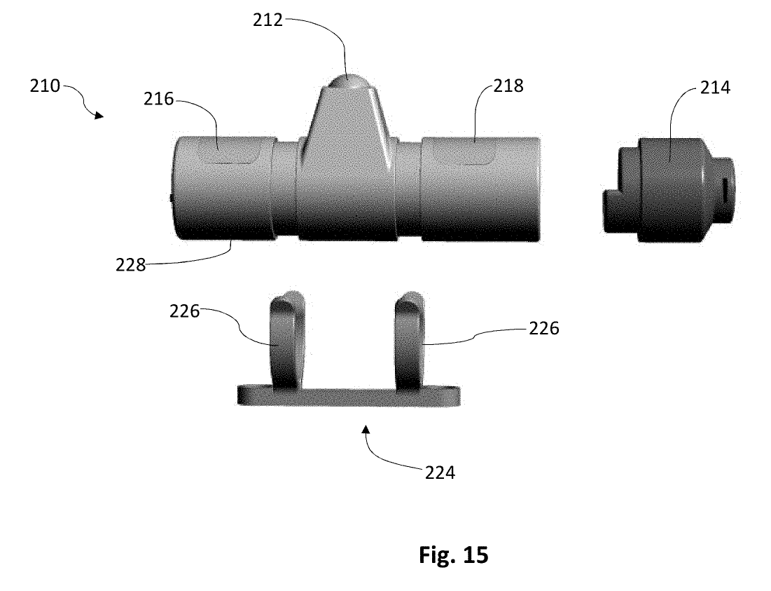

Further, as best shown in FIGS. 14-15, the diffuser 212 is removably attachable, allowing a user to easily change the diffuser cartridge when the contents (e.g., essential oils) are depleted or to change the scent. Further, the sensor unit 210 comprises a housing clamp 224. The housing clamp 224 may be secured to the footrest 100 using screws or other fasteners. The tension arms 226 then secure the body 228 therein, allowing easy removal and replacement by a user. This affords a user with the ability to easily charge the battery and/or replace the diffuser 212 without needing to unscrew the sensor unit 212 from the toilet footrest 100 and generally without even needing to invert the toilet footrest.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A lighted toilet footrest, comprising:
a foot platform;
a sidewall extending downwardly from the foot platform;
a plurality of legs; and
a sensor unit, the sensor unit comprising a light sensor, a motion sensor, and one or more lights.

2. The lighted toilet footrest of claim 1, wherein the sidewall comprises a motion sensor aperture.

3. The lighted toilet footrest of claim 1, wherein the sensor unit further comprises a diffuser.

4. The lighted toilet footrest of claim 3, wherein the diffuser is motion activated.

5. The lighted toilet footrest of claim 1, wherein the sensor unit is coupled to the foot platform via a housing clamp.

6. A lighted toilet footrest, comprising:
a foot platform comprising a curvature for abutting a toilet;
a sidewall extending downwardly from the foot platform;
a plurality of legs; and
a sensor unit, comprising:
a light sensor;
a motion sensor;
one or more lights; and
a diffuser;
wherein the diffuser and lights are controlled via the motion sensor.

7. The lighted toilet footrest of claim 6, wherein the diffuser is removably attachable.

8. The lighted toilet footrest of claim 6, wherein the sensor unit is removably attachable to the foot platform via a housing clamp.

9. The lighted toilet footrest of claim 6, wherein the sensor unit comprises a charging port.
